(19) United States
(12) Patent Application Publication
(10) Pub. No.: US 2024/0078386 A1
(43) Pub. Date: Mar. 7, 2024

(54) METHODS AND SYSTEMS FOR LANGUAGE-AGNOSTIC MACHINE LEARNING IN NATURAL LANGUAGE PROCESSING USING FEATURE EXTRACTION

(71) Applicant: 100.co Global Holdings, LLC, Miami, FL (US)

(72) Inventors: Robert J. Munro, San Francisco, CA (US); Schuyler D. Erle, San Francisco, CA (US); Tyler J. Schnoebelen, San Francisco, CA (US); Brendan D. Callahan, Philidelphia, PA (US); Jessica D. Long, San Francisco, CA (US); Gary C. King, Los Altos, CA (US); Paul A. Tepper, San Francisco, CA (US); Jason A. Brenier, Oakland, CA (US); Stefan Krawczyk, Menlo Park, CA (US)

(73) Assignee: 100.co Global Holdings, LLC, Miami, FL (US)

(21) Appl. No.: 18/500,784

(22) Filed: Nov. 2, 2023

Related U.S. Application Data
(63) Continuation of application No. 16/862,518, filed on Apr. 29, 2020, now abandoned.
Application No. 16/862,518 is a continuation of application No. 16/238,352, filed on Jan. 2, 2019, now abandoned.
Application No. 16/238,352 is a continuation of application No. 15/814,349, filed on Nov. 15, 2017, now abandoned.
Application No. 15/814,349 is a continuation of application No. 14/964,525, filed on Dec. 9, 2015, now abandoned.
(60) Provisional application No. 62/089,736, filed on Dec. 9, 2014.
(60) Provisional application No. 62/089,742, filed on Dec. 9, 2014.
(60) Provisional application No. 62/089,745, filed on Dec. 9, 2014.
(60) Provisional application No. 62/089,747, filed on Dec. 9, 2014.
(60) Provisional application No. 62/254,090, filed on Nov. 11, 2015.
(60) Provisional application No. 62/254,095, filed on Nov. 11, 2015.

(51) Int. Cl. G06F 40/284; G06F 40/216; G06F 40/30

(52) U.S. Cl. CPC G06F 40/284; G06F 40/216; G06F 40/30

(57) ABSTRACT

Methods, apparatuses, and systems are presented for generating natural language models using a novel system architecture for feature extraction. A method for extracting features for natural language processing comprises: accessing one or more tokens generated from a document to be processed; receiving one or more feature types defined by user; receiving selection of one or more feature types from a plurality of system-defined and user-defined feature types, wherein each feature type comprises one or more rules for generating features; receiving one or more parameters for the selected feature types, wherein the one or more rules for generating features are defined at least in part by the parameters; generating features associated with the document to be processed based on the selected feature types and the received parameters; and outputting the generated features in a format common among all feature types.

### CROSS REFERENCES TO RELATED APPLICATIONS

This application is a continuation of U.S. patent application Ser. No. 16/238,352, filed Jan. 2, 2019, and titled “METHODS AND SYSTEMS FOR LANGUAGE-AGNOSTIC MACHINE LEARNING IN NATURAL LANGUAGE PROCESSING USING FEATURE EXTRACTION,” which is a continuation of U.S. patent application Ser. No. 15/814,349, filed Nov. 15, 2017, and titled “METHODS AND SYSTEMS FOR LANGUAGE-AGNOSTIC MACHINE LEARNING IN NATURAL LANGUAGE PROCESSING USING FEATURE EXTRACTION,” which is a continuation of U.S. patent application Ser. No. 14/964,525, filed Dec. 9, 2015, and titled “METHODS AND SYSTEMS FOR LANGUAGE-AGNOSTIC MACHINE LEARNING IN NATURAL LANGUAGE PROCESSING USING FEATURE EXTRACTION,” which claims the benefits of U.S. Provisional Application 62/089,736, filed Dec. 9, 2014, and titled, “METHODS AND SYSTEMS FOR ANNOTATING NATURAL LANGUAGE PROCESSING,” U.S. Provisional Application 62/089,742, filed Dec. 9, 2014, and titled, “METHODS AND SYSTEMS FOR IMPROVING MACHINE PERFORMANCE IN NATURAL LANGUAGE PROCESSING,” U.S. Provisional Application 62/089,745, filed Dec. 9, 2014, and titled, “METHODS AND SYSTEMS FOR IMPROVING FUNCTIONALITY IN NATURAL LANGUAGE PROCESSING,” U.S. Provisional Application 62/089,747, filed Dec. 9, 2014, and titled, “METHODS AND SYSTEMS FOR SUPPORTING NATURAL LANGUAGE PROCESSING,” U.S.

Provisional Application 62/254,090, filed Nov. 11, 2015, and titled “TOKENIZER AND TAGGER FOR LANGUAGE AGNOSTIC METHODS FOR NATURAL LANGUAGE PROCESSING,” and U.S. Provisional Application 62/254,095, filed Nov. 11, 2015, and titled “METHODS FOR MACHINE LEARNING IN NATURAL LANGUAGE MODELS USING FEATURE EXTRACTION,” the disclosures of which are incorporated herein in their entirety and for all purposes.

This application is also related to U.S. patent application Ser. No. 14/964,517, filed Dec. 9, 2015, titled “METHODS FOR GENERATING NATURAL LANGUAGE PROCESSING SYSTEMS,” U.S. patent application Ser. No. 14/964,518, filed Dec. 9, 2015, titled “ARCHITECTURES FOR NATURAL LANGUAGE PROCESSING,” U.S. patent application Ser. No. 14/964,520, filed Dec. 9, 2015, titled “OPTIMIZATION TECHNIQUES FOR ARTIFICIAL INTELLIGENCE,” U.S. patent application Ser. No. 14/964,522, filed Dec. 9, 2015, titled “GRAPHICAL SYSTEMS AND METHODS FOR HUMAN-IN-THE-LOOP MACHINE INTELLIGENCE,” U.S. patent application Ser. No. 14/964,510, filed Dec. 9, 2015, titled “METHODS AND SYSTEMS FOR IMPROVING MACHINE LEARNING PERFORMANCE,” U.S. patent application Ser. No. 14/964,511, filed Dec. 9, 2015, titled “METHODS AND SYSTEMS FOR MODELING COMPLEX TAXONOMIES WITH NATURAL LANGUAGE UNDERSTANDING,” U.S. patent application Ser. No. 14/964,512, filed Dec. 9, 2015, titled “AN INTELLIGENT SYSTEM THAT DYNAMICALLY IMPROVES ITS KNOWLEDGE AND CODE-BASE FOR NATURAL LANGUAGE UNDERSTANDING,” U.S. patent application Ser. No. 14/964,526, filed Dec. 9, 2015, titled “METHODS AND SYSTEMS FOR PROVIDING UNIVERSAL PORTABILITY IN MACHINE LEARNING,” and U.S. patent application Ser. No. 14/964,528, filed Dec. 9, 2015, titled “TECHNIQUES FOR COMBINING HUMAN AND MACHINE LEARNING IN NATURAL LANGUAGE PROCESSING,” the entire contents and substance of all of which are hereby incorporated in total by reference in their entireties and for all purposes.

### TECHNICAL FIELD

The subject matter disclosed herein generally relates to processing data. In some example embodiments, the present disclosures relate to methods for machine learning in natural language models using feature extraction.

### BACKGROUND

There is a need for assisting customers or users to accurately and expediently process human communications brought upon by the capabilities of the digital age. The modes of human communications brought upon by digital technologies have created a deluge of information that can be difficult for human readers to handle alone. Companies and research groups may want to determine trends in the human communications to determine what people generally care about for any particular topic, whether it be what car features are being most expressed on Twitter®, what political topics are being most expressed on Facebook®, what people are saying about the customer's latest product in their customer feedback page, and so forth. It may be desirable for companies to aggregate and then synthesize the thousands or even millions of human communications from the many different modes available in the digital age (e.g., Twitter®, blogs, email, etc.). Processing all this information by humans alone can be overwhelming and cost-inefficient. Methods today may therefore rely on computers to apply natural language processing in order to interpret the many human communications available in order to analyze, group, and ultimately categorize the many human communications into digestible patterns of communication.

### BRIEF SUMMARY

A method for extracting features for natural language processing comprises: accessing, by one or more processors in a natural language processing platform, one or more tokens generated from a document to be processed; receiving, by the one or more processors, one or more feature types defined by user; receiving, by the one or more processors, selection of one or more feature types from a plurality of system-defined and user-defined feature types, wherein each feature type comprises one or more rules for generating features; receiving, by the one or more processors, one or more parameters for the selected feature types, wherein the one or more rules for generating features are defined at least in part by the parameters; generating, by the one or more processors, features associated with the document to be processed based on the selected feature types and the received parameters; and outputting, by the one or more processors, the generated features in a format common among all feature types.

In some embodiments, the plurality of feature types comprises one or more feature types that generate features each comprising at least one combination of the accessed tokens.

In some embodiments, the method further comprises accessing one or more tags attached to the one or more tokens, wherein the plurality of feature types comprises one or more feature types that generate features containing information in the tags.

In some embodiments, the method further comprises accessing metadata associated with the document to be processed, wherein the plurality of feature types comprises one or more feature types that generate features containing information in the metadata.

In some embodiments, the plurality of feature types comprises a feature type that generates features each comprising information in the metadata and a combination of tokens.

In some embodiments, the method further comprises generating statistics across a pool of documents, wherein the plurality of feature types comprises one or more feature types that generate features based on the statistics.

In some embodiments, the statistics comprise an average or median document length in the pool, and the plurality of feature types comprises a feature type that generates a feature indicating whether the document to be processed is longer than, is shorter than, or equals to the average or median document length.

In some embodiments, the method further comprises accessing a list of entries, wherein the plurality of feature types comprises a feature type that generates a feature indicating whether the document to be processed contains one or more tokens that match one or more of the list of entries.

In some embodiments, the method further comprises accessing a list of word vectors, wherein the plurality of feature types comprises a feature type that generates features containing one or more word vectors each corresponding to a combination of the accessed tokens.

In some embodiments, the method further comprises: calculating frequencies of occurrence of one or more generated features within a pool of documents; and storing the frequencies of occurrence in a format accessible by a module for submitting documents for human annotation.

In some embodiments, the method further comprises presenting, in a user interface, one or more features associated with a document.

In some embodiments, the document to be processed is in one or more languages; the one or more tokens are accessed in a language agnostic format; and the generated features are outputted in a language agnostic format.

In some embodiments, an apparatus for extracting features for natural language processing comprises one or more processors configured to: access one or more tokens generated from a document to be processed; receive one or more feature types defined by user; receive selection of one or more feature types from a plurality of system-defined and user-defined feature types, wherein each feature type comprises one or more rules for generating features; receive one or more parameters for the selected feature types, wherein the one or more rules for generating features are defined at least in part by the parameters; generate features associated with the document to be processed based on the selected feature types and the received parameters; and output the generated features in a format common among all feature types.

In some embodiments, a non-transitory computer readable medium comprises instructions that, when executed by a processor, cause the processor to: access one or more tokens generated from a document to be processed; receive one or more feature types defined by user; receive selection of one or more feature types from a plurality of system-defined and user-defined feature types, wherein each feature type comprises one or more rules for generating features; receive one or more parameters for the selected feature types, wherein the one or more rules for generating features are defined at least in part by the parameters; generate features associated with the document to be processed based on the selected feature types and the received parameters; and output the generated features in a format common among all feature types.

### BRIEF DESCRIPTION OF THE DRAWINGS

Some embodiments are illustrated by way of example and not limitation in the figures of the accompanying drawings.

FIG. 1 is a network diagram illustrating an example network environment suitable for performing aspects of the present disclosure, according to some example embodiments.

FIG. 2 is a diagram showing an example system architecture for performing aspects of the present disclosure, according to some example embodiments

FIG. 3 is a high level diagram showing various examples of types of human communications and what the objectives may be for a natural language model to accomplish, according to some example embodiments.

FIG. 4 is a diagram showing an example flowchart for how different data structures within the system architecture may be related to one another, according to some example embodiments.

FIG. 5 is a flowchart showing an example methodology for processing the human communications in a document into an array of features using an example feature type, according to some embodiments.

FIG. 6 is flowchart showing an example feature extraction process according to some embodiments.

FIG. 7 is a chart showing an example set of feature types, according to some embodiments.

FIG. 8 shows an example user interface for selection of feature types.

FIG. 9 shows an example output of an array of features based on the feature type, “Bag of Words,” as described in the chart in FIG. 7, according to some embodiments.

FIG. 10 shows another example output of an array of features based on the feature type, “NGrams,” as described in the chart in FIG. 7, according to some embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented for generating natural language models using a novel system architecture for feature extraction. A natural language model may classify each document in a collection of documents into specified topics or labels (referred to herein as a document-scope task), or extract portions of text of the documents related to specified topics or labels (referred to herein as a span-scope task). As referred to herein, feature extraction is a computerized concept that is used to identify information from textual documents that can be used to help train natural language models and process untested data. Traditionally, the concept of feature extraction involves converting the text of a document into an array of strings (e.g., a plurality of textual characters, referred to herein as features) based on a set of rules defined by a particular feature extracting algorithm, referred to herein as a feature type. Examples of feature types used to produce an array of features will be described more below.

In some embodiments, before the performance of feature extraction, a document is partitioned into a number of smaller pieces of text, typically referred to as tokens. The feature extracting algorithm may be performed on the tokens, depending on the particular feature type of feature types selected. For example, a feature type may designate each of the tokens as a feature. As another example, a feature type may designate each pair of adjacent tokens as a feature. More than one feature type may be utilized at the same time. For example, the features may include each of the tokens and each pair of adjacent tokens. There may be an infinite number of system-defined feature types and/or user-defined feature types.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

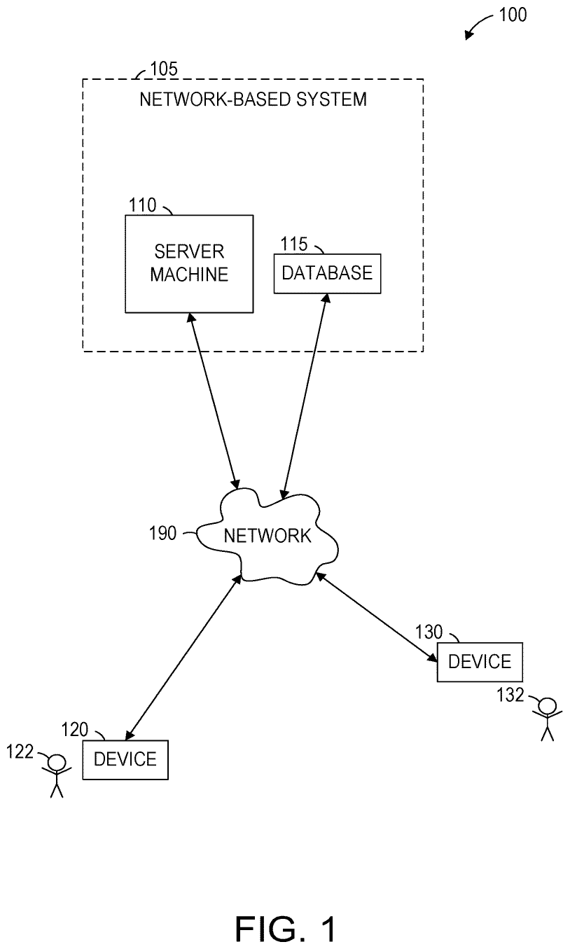

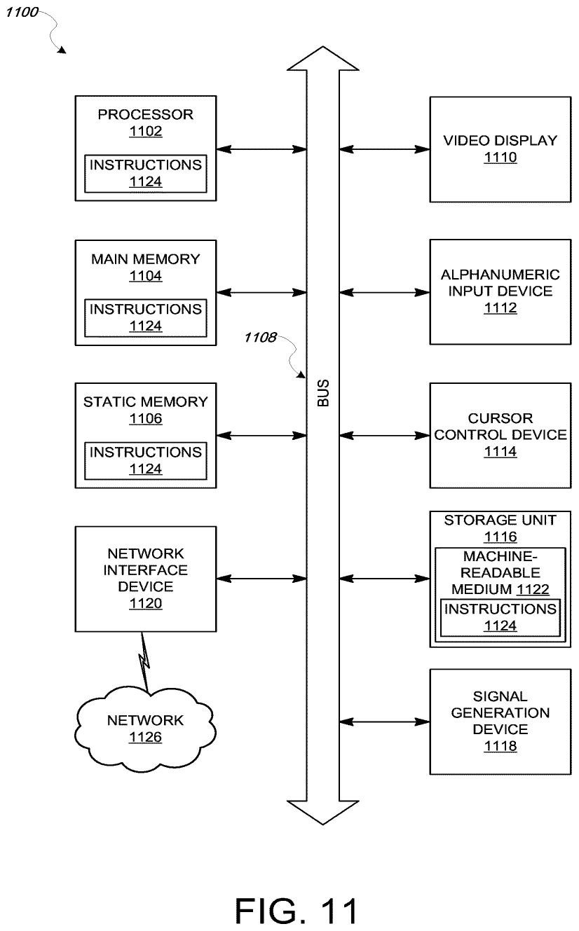

Referring to FIG. 1, a network diagram illustrating an example network environment 100 suitable for performing aspects of the present disclosure is shown, according to some example embodiments. The example network environment 100 includes a server machine 110, a database 115, a first device 120 for a first user 122, and a second device 130 for a second user 132, all communicatively coupled to each other via a network 190. The server machine 110 may form all or part of a network-based system 105 (e.g., a cloud-based server system configured to provide one or more services to the first and second devices 120 and 130). The server machine 110, the first device 120, and the second device 130 may each be implemented in a computer system, in whole or in part, as described below with respect to FIG. 11. The network-based system 105 may be an example of a natural language platform configured to generate natural language models as described herein. The server machine 110 and the database 115 may be components of the natural language platform configured to perform these functions. While the server machine 110 is represented as just a single machine and the database 115 where is represented as just a single database, in some embodiments, multiple server machines and multiple databases communicatively coupled in parallel or in serial may be utilized, and embodiments are not so limited.

Also shown in FIG. 1 are a first user 122 and a second user 132. One or both of the first and second users 122 and 132 may be a human user, a machine user (e.g., a computer configured by a software program to interact with the first device 120), or any suitable combination thereof (e.g., a human assisted by a machine or a machine supervised by a human). The first user 122 may be associated with the first device 120 and may be a user of the first device 120. For example, the first device 120 may be a desktop computer, a vehicle computer, a tablet computer, a navigational device, a portable media device, a smartphone, or a wearable device (e.g., a smart watch or smart glasses) belonging to the first user 122. Likewise, the second user 132 may be associated with the second device 130. As an example, the second device 130 may be a desktop computer, a vehicle computer, a tablet computer, a navigational device, a portable media device, a smartphone, or a wearable device (e.g., a smart watch or smart glasses) belonging to the second user 132. The first user 122 and a second user 132 may be examples of users or customers interfacing with the network-based system 105 to utilize a natural language model according to their specific needs. In other cases, the users 122 and 132 may be examples of annotators who are supplying annotations to documents to be used for training purposes when developing a natural language model. In other cases, the users 122 and 132 may be examples of analysts who are providing inputs to the natural language platform to more efficiently train the natural language model. The users 122 and 132 may interface with the network-based system 105 through the devices 120 and 130, respectively.

Any of the machines, databases 115, or first or second devices 120 or 130 shown in FIG. 1 may be implemented in a general-purpose computer modified (e.g., configured or programmed) by software (e.g., one or more software modules) to be a special-purpose computer to perform one or more of the functions described herein for that machine, database 115, or first or second device 120 or 130. For example, a computer system able to implement any one or more of the methodologies described herein is discussed below with respect to FIG. 11. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases 115, and devices (e.g., the server machine 110 and the first device 120). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

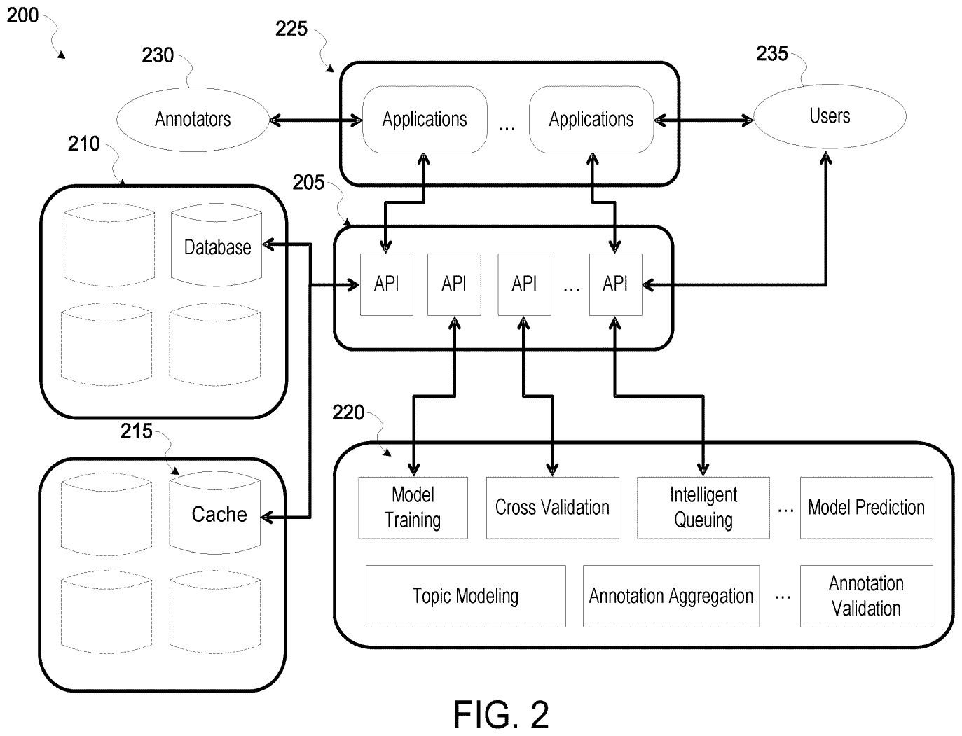

Referring to FIG. 2, a diagram 200 is presented showing an example system architecture for performing aspects of the present disclosure, according to some example embodiments. The example system architecture according to diagram 200 represents various data structures and their interrelationships that may comprise a natural language platform, such as the natural language platform 170, or the network-based system 105. These various data structures may be implemented through a combination of hardware and software, the details of which may be apparent to those with skill in the art based on the descriptions of the various data structures described herein. For example, an API module 205 includes one or more API processors, where multiple API processors may be connected in parallel. In some example embodiments, the repeating boxes in the diagram 200 represent identical servers or machines, to signify that the system architecture in diagram 200 may be scalable to an arbitrary degree. The API module 205 may represent a point of contact for multiple other modules, includes a database module 210, a cache module 215, background processes module 220, applications module 225, and even an interface for users 235 in some example embodiments. The API module 205 may be configured to receive or access data from database module 210. The data may include digital forms of thousands or millions of human communications. The cache module 215 may store in more accessible memory various information from the database module 210 or from users 235 or other subscribers. Because the database module 210 and cache module 215 show accessibility through API module 205, the API module 205 can also support authentication and authorization of the data in these modules. The background module 220 may be configured to perform a number of background processes for aiding natural language processing functionality. Various examples of the background processes include a model training module, a cross validation module, an intelligent queuing module, a model prediction module, a topic modeling module, an annotation aggregation module, an annotation validation module, and a feature extraction module. These various modules are described in more detail below as well as in U.S. patent application Ser. No. 14/964,520, filed Dec. 9, 2015, titled “OPTIMIZATION TECHNIQUES FOR ARTIFICIAL INTELLIGENCE,” U.S. patent application Ser. No. 14/964,522, filed Dec. 9, 2015, titled “GRAPHICAL SYSTEMS AND METHODS FOR HUMAN-IN-THE-LOOP MACHINE INTELLIGENCE,” U.S. patent application Ser. No. 14/964,510, filed Dec. 9, 2015, titled “METHODS AND SYSTEMS FOR IMPROVING MACHINE LEARNING PERFORMANCE,” U.S. patent application Ser. No. 14/964,512, filed Dec. 9, 2015, titled “INTELLIGENT SYSTEM THAT DYNAMICALLY IMPROVES ITS KNOWLEDGE AND CODE-BASE FOR NATURAL LANGUAGE UNDERSTANDING,” and U.S. patent application Ser. No. 14/964,528, filed Dec. 9, 2015, titled “TECHNIQUES FOR COMBINING HUMAN AND MACHINE LEARNING IN NATURAL LANGUAGE PROCESSING,” each of which are again incorporated by reference in their entireties. The API module 205 may also be configured to support display and functionality of one or more applications in applications module 225.

In some embodiments, the API module 205 may be configured to provide as an output the natural language model packaged in a computationally- and memory-efficient manner. The natural language model may then be transmitted to multiple client devices, such as devices 120 and 130, including transmitting to mobile devices and other machines with less memory and less processing power.

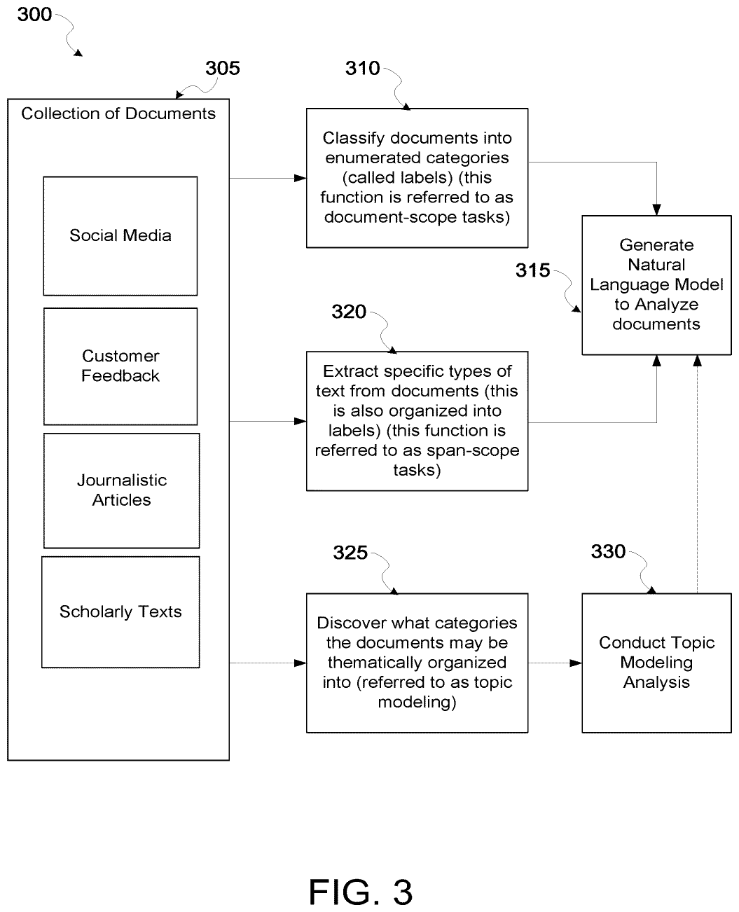

Referring to FIG. 3, a high level diagram 300 is presented showing various examples of types of human communications and what the objectives may be for a natural language model to accomplish, according to some example embodiments. Here, various sources of data, sometimes referred to as a collection of documents 305, may be obtained and stored in, for example database 115, client data store 155, or database modules 210, and may represent different types of human communications, all capable of being analyzed by a natural language model. Examples of the types of documents 305 include, but are not limited to, posts in social media, emails or other writings for customer feedback, pieces of or whole journalistic articles, commands spoken or written to electronic devices, transcribed call center recordings; electronic (instant) messages; corporate communications (e.g., SEC 10-k, 10-q); confidential documents and communications stored on internal collaboration systems (e.g., SharePoint, Notes), and pieces of or whole scholarly texts.

In some embodiments, at block 310, it may be desired to classify any of the documents 305 into a number of enumerated categories or topics, consistent with some of the descriptions mentioned above. This may be referred to as performing a document-scope task. For example, a user 130 in telecommunications may supply thousands of customer service emails related to services provided by a telecommunications company. The user 130 may desire to have a natural language model generated that classifies the emails into predetermined categories, such as negative sentiment about their Internet service, positive sentiment about their Internet service, negative sentiment about their cable service, and positive sentiment about their cable service. As previously mentioned, these various categories for which a natural language model may classify the emails into, e.g. “negative” sentiment about “Internet service,” “positive” sentiment about “Internet service,” “negative” sentiment about “cable service,” etc., may be referred to as “labels.” Based on these objectives, at block 315, a natural language model may be generated that is tailored to classify these types of emails into these types of labels.

As another example, in some embodiments, at block 320, it may be desired to extract specific subsets of text from documents, consistent with some of the descriptions mentioned above. This may be another example of performing a span-scope task, in reference to the fact that this function focuses on a subset within each document (as previously mentioned, referred to herein as a “span”). For example, a user 130 may desire to identify all instances of a keyword, key phrase, or general subject matter within a novel. Certainly, this span scope task may be applied to multiple novels or other documents. Another example includes a company that may want to extract phrases that correspond to products or product features (e.g., “iPhone 5” or “battery life”). Here too, based on this objective, at block 315, a natural language model may be generated that is tailored to perform this function for a specified number of documents.

As another example, in some embodiments, at block 325, it may be desired to discover what categories the documents may be thematically or topically organized into in the first place, consistent with descriptions above about topic modeling. In some cases, the user 130 may utilize the natural language platform only to perform topic modeling and to discover what topics are most discussed in a specified collection of documents 305. To this end, the natural language platform may be configured to conduct topic modeling analysis at block 330. In some cases, it may be desired to then generate a natural language model that categorizes the documents 305 into these newfound topics. Thus, after performing the topic modeling analysis 230, in some embodiments, the natural language model may also be generated at block 315.

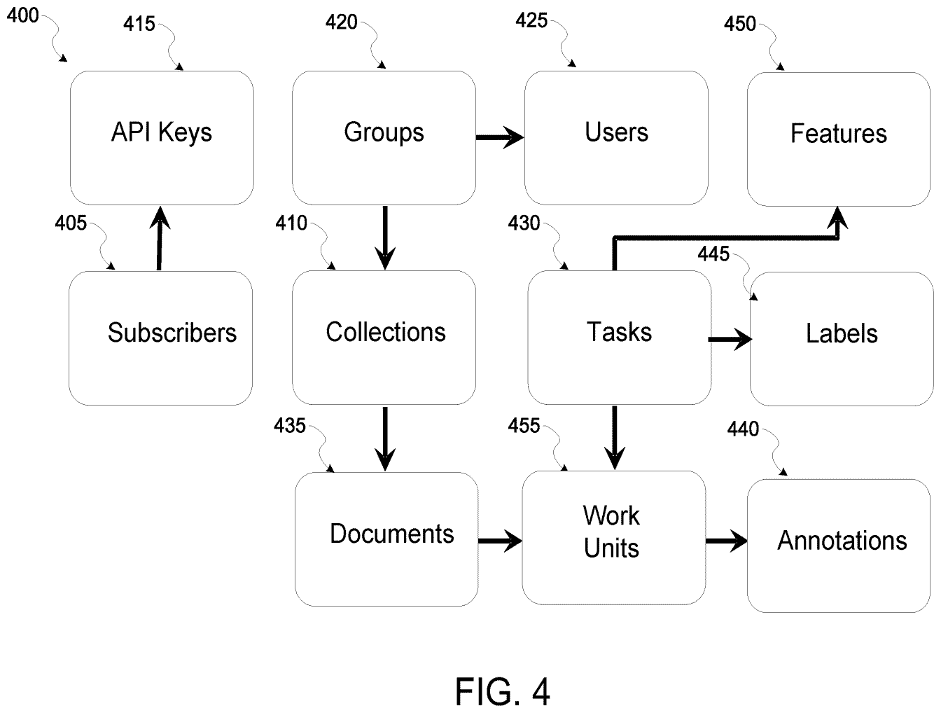

Referring to FIG. 4, a diagram 400 is presented showing an example flowchart for how different data structures within the system architecture may be related to one another, according to some example embodiments. Here, the collections data structure 410 represents a set of documents 435 that in some cases may generally be homogenous. A document 435 represents a human communication expressed in a single discrete package, such as a single tweet, a webpage, a chapter of a book, a command to a device, or a journal article, or any part thereof. Each collection 410 may have one or more tasks 430 associated with it. A task 430 may be thought of as a classification scheme. For example, a collection 410 of tweets may be classified by its sentiment, e.g. a positive sentiment or a negative sentiment, where each classification constitutes a task 430 about a collection 410. A label 445 refers to a specific prediction about a specific classification. For example, a label 445 may be the “positive sentiment” of a human communication, or the “negative sentiment” of a human communication. In some cases, labels 445 can be applied to merely portions of documents 435, such as paragraphs in an article or particular names or places mentioned in a document 435. For example, a label 445 may be a “positive opinion” expressed about a product mentioned in a human communication, or a “negative opinion” expressed about a product mentioned in a human communication. In some example embodiments, a task may be a sub-task of another task, allowing for a hierarchy or complex network of tasks. For example, if a task has a label of “positive opinion,” there might be sub-tasks for types of “positives opinions,” like “intention to purchase the product,” “positive review,” “recommendation to friend,” and so on, and there may be subtasks that capture other relevant information, such as “positive features.”

Annotations 440 refer to classifications imputed onto a collection 410 or a document 435, often times by human input but may also be added by programmatic means, such as interpolating from available metadata (e.g., customer value, geographic location, etc.), generated by a pre-existing natural language model, or generated by a topic modeling process. As an example, an annotation 440 applies a label 445 manually to a document 435. In other cases, annotations 440 are provided by users 235 from pre-existing data. In other cases, annotations 440 may be derived from human critiques of one or more documents 435, where the computer determines what annotation 440 should be placed on a document 435 (or collection 410) based on the human critique. In other cases, with enough data in a language model, annotations 440 of a collection 410 can be derived from one or more patterns of pre-existing annotations found in the collection 410 or a similar collection 410.

In some example embodiments, features 450 refer to a library or collection of certain key words or groups of words that may be used to determine whether a task 430 should be associated with a collection 410 or document 435. Thus, each task 430 has associated with it one or more features 450 that help define the task 430. In some example embodiments, features 450 can also include a length of words or other linguistic descriptions about the language structure of a document 435, in order to define the task 430. For example, classifying a document 435 as being a legal document may be based on determining if the document 435 contains a threshold number of words with particularly long lengths, words belonging to a pre-defined dictionary of legal-terms, or words that are related through syntactic structures and semantic relationships. In some example embodiments, features 450 are defined by code, while in other cases features 450 are discovered by statistical methods. In some example embodiments, features 450 are treated independently, while in other cases features 450 are networked combinations of simpler features that are used in combination utilizing techniques like “deep-learning.” In some example embodiments, combinations of the methods described herein may be used to define the features 450, and embodiments are not so limited. One or more processors may be used to identify in a document 435 the words found in features data structure 450 to determine what task should be associated with the document 435.

In some example embodiments, a work unit's data structure 455 specifies when humans should be tasked to further examine a document 425. Thus, human annotations may be applied to a document 435 after one or more work units 455 is applied to the document 435. The work units 455 may specify how many human annotators should examine the document 435 and in what order of documents should document 435 be examined. In some example embodiments, work units 455 may also determine what annotations should be reviewed in a particular document 435 and what the optimal user interface should be for review.

In some example embodiments, the data structures 405, 415, 420 and 425 represent data groupings related to user authentication and user access to data in system architecture. For example, the subscribers block 405 may represent users and associated identification information about the users. The subscribers 405 may have associated API keys 415, which may represent one or more authentication data structures used to authenticate subscribers and provide access to the collections 410. Groups 420 may represent a grouping of subscribers based on one or more common traits, such as subscribers 405 belonging to the same company. Individual users 425 capable of accessing the collections 410 may also result from one or more groups 420. In addition, in some cases, each group 420, user 425, or subscriber 405 may have associated with it a more personalized or customized set of collections 510, documents 435, annotations 440, tasks, 430, features 450, and labels 445, based on the specific needs of the customer.

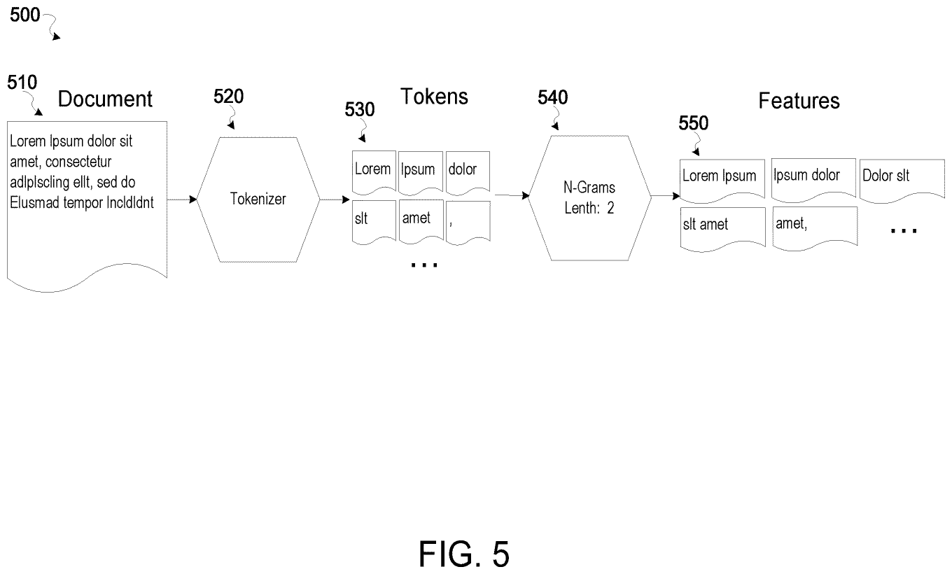

Referring to FIG. 5, flowchart 500 shows an example methodology for processing the human communications in a document into an array of features using an example feature type, according to some embodiments. The flowchart 500 provides simply one example for the general concept of feature extraction, an example type of inputs, and an example type of outputs. This example may be generalized to utilize other feature types based on the rationale provided herein, and embodiments are not so limited.

The example process starts with step 510, beginning with containing text representing human communications. Step 510 may be generalized to include a subset of the document, referred to as a span, or multiple documents. In general, the process begins with a set of text with an arbitrary length. The text may be written in any language, and in some embodiments, the text may include more than one language. The architecture of the present disclosure is configured to process text of the documents regardless of what language or how many languages are included.

At step 520, the text of the document may be partitioned into a plurality of tokens, which are strings organized in a consistent manner (e.g., the document is subdivided into an array of tokens, such as single words or parts thereof, spaces, punctuation, substrings of words that have meaningful internal boundaries, and groups of words, in the order they appear) by a tokenizer program or engine. The tokenizer may be configured to handle any number of languages, including if the document is written in multiple languages. In some embodiments, the tokenizer outputs the document into a number of tokens that is organized in a common format, regardless of the type of language or number of languages. A more detailed description of an example tokenizer is described in U.S. patent application Ser. No. 14/964,512, filed Dec. 9, 2015, titled “INTELLIGENT SYSTEM THAT DYNAMICALLY IMPROVES ITS KNOWLEDGE AND CODE-BASE FOR NATURAL LANGUAGE UNDERSTANDING,” which is again incorporated by reference in its entirety. An example array of the tokens is shown in step 530, which is based on the example filler language illustrated in the document at step 510.

At step 540, the feature extraction architecture according to aspects of the present disclosure takes as input for a feature type the array of tokens in step 530, processed by the tokenizer at step 520, according to some embodiments. Since the array of tokens may be outputted by the tokenizer into a common format, regardless of the language, the feature type used at step 540 may reliably accept as input any array of tokens processed by the tokenizer, due to the common format. In this example, a feature type called “N-Grams” is selected to convert the array of tokens in step 530 into an array of features at step 550. In this case, the N-Grams feature type takes as an input in array of tokens, which may include punctuation, and outputs an array of pairwise tokens, i.e., the first and second token are combined into a first feature in the array of features, the second and third token are combined into a second feature, the third and fourth token are combined into a third feature, and so on, as shown. Thus, the array of features at step 550 represents one example of a more sophisticated permutation of the tokens comprising the original document. A natural language model may be trained on this array of features, along with many other different types of arrays of features. In general, many other feature types may be used to process the array of tokens at step 530 into a different set of features at step 550. Examples of different feature types are described more below.

After the performance of step 550, a limited number of features, e.g., 100,000 features for a label, may be selected based on a feature scorer (referred to herein as feature selection). The feature scorer, for example, may score each feature based on its frequency of appearance in the documents. For each selected feature, a probability may be calculated based on human annotation. For example, when there are many instances where a document containing a particular feature is classified into a category (label) by human annotation, that feature will have a high probability with respect to that label. Then a table may be generated for each label containing the selected features and their respective probabilities. Examples table rows are shown below for a document-scope task and a span-scope task, respectively.

| Feature Name | In(p(Label1)) | In(p(!Label1)) | In(p(Label2)) | In(p(!Label2)) |
|---|---|---|---|---|
| type = BagOfWords | −0.6733 | −0.7133 | −0.5978 | −0.7985 |
| feature = Lorem | | | | |

| Feature Name | In(p(Label1_{begin})) | In(p(Label1_{inside})) | In(p(Label1_{outside})) |
|---|---|---|---|
| type = SpanWords | −0.5108 | −1.3863 | −1.8971 |
| feature = the United | | | |
| offs = −1 | | | |

In some embodiments, the table, as part of the result of machine learning, will in turn be used by document-scope tasks for processing untested documents based on the following equations:

$${odds}_{ml}^{label} = {e}^{{\sum }_{f ∈ features} ( ρ ( label \vert f ) - ρ ( ! label \vert f ) )}$$

$${p}_{m l}^{label} = \frac{{odds}_{m l}^{label}}{1 + {odds}_{m l}^{l a b e l}}$$

In some embodiments, the table, as part of the result of machine learning, will in turn be used by span-scope tasks for processing untested documents based on the following equations:

locations={begin,inside,outside}

p_{s∈locations}=e^{Σ}^{_{f∈features}}^{p}(labelₛ|f)

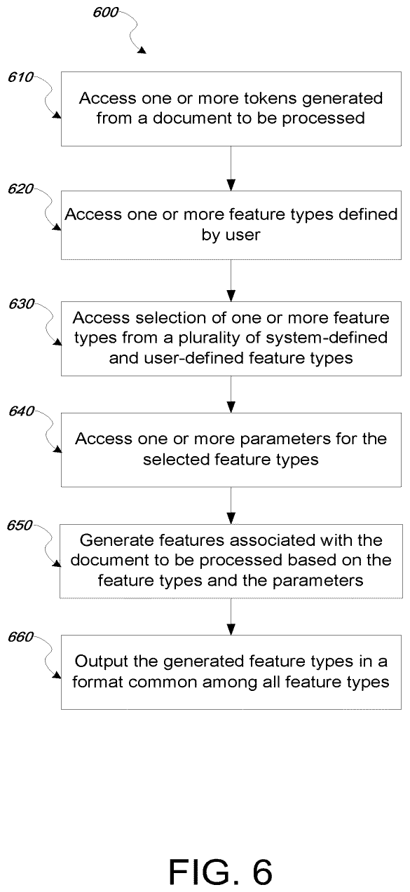

Referring to FIG. 6, flowchart 600 shows an example feature extraction process according to some embodiments. Various steps in the example feature extraction process may be performed by one or more processors in a natural language processing platform.

At step 610, the process begins by accessing one or more tokens generated from a document to be processed. A more detailed description of example tokenization is described in n U.S. patent application Ser. No. 14/964,512, filed Dec. 9, 2015, titled “INTELLIGENT SYSTEM THAT DYNAMICALLY IMPROVES ITS KNOWLEDGE AND CODE-BASE FOR NATURAL LANGUAGE UNDERSTANDING,” which is again incorporated by reference in its entirety.

At step 620, the process continues by receiving one or more feature types defined by user. A feature type comprises one or more rules for generating features. For example, the feature extracting algorithm may perform an arbitrary user-specified data transformation to designate one or more of the document text, tokens, tags associated with tokens, or metadata as features according to a criteria specified by the user. In some embodiments, this transformation is specified using a programming language embedded within the feature extracting algorithm, such as Javascript. Therefore, users are allowed to supply executable code (implemented as Javascript) that implements their own custom feature types within the feature extraction framework. This way, if analysts notice that there is a pattern to their data that is not already represented within the system, they may supply a feature transformation for that pattern without needing any changes to the core software platform.

At step 630, the process continues by receiving selection of one or more feature types from a plurality of system-defined and user-defined feature types, wherein each feature type comprises one or more rules for generating features. In some embodiments, the system architecture for feature extraction presented herein allows for a nearly infinite number of feature types to be designed and programmed. Conventional methods for performing feature extraction for natural language processing often are not programmed or designed with a common output format or input format across multiple feature types. That is, one feature type may be designed to accept a first set of inputs and have an output with a first format, while a second feature type may be designed to accept a second set of inputs and have an output with a second format that are different than the first set of inputs and first format, respectively. Based on this lack of common, foundational architecture, a set of text may be suitable to be used in only one feature type, while the set of text may be unsuitable to be used in a second feature type, as may commonly be the case in conventional feature extraction architecture. In contrast, the present disclosures include a common, foundational feature extraction architecture that allows for all feature types to accept as inputs a common format, and also outputs features organized in a common format, thereby allowing one set of text to be processed by essentially any and all feature types. In this way, the present disclosures also allow for clients and customers to customize their own feature types that may best cater to their needs for building a specific type of natural language model. A description of the common input format and the common output format will be described more below.

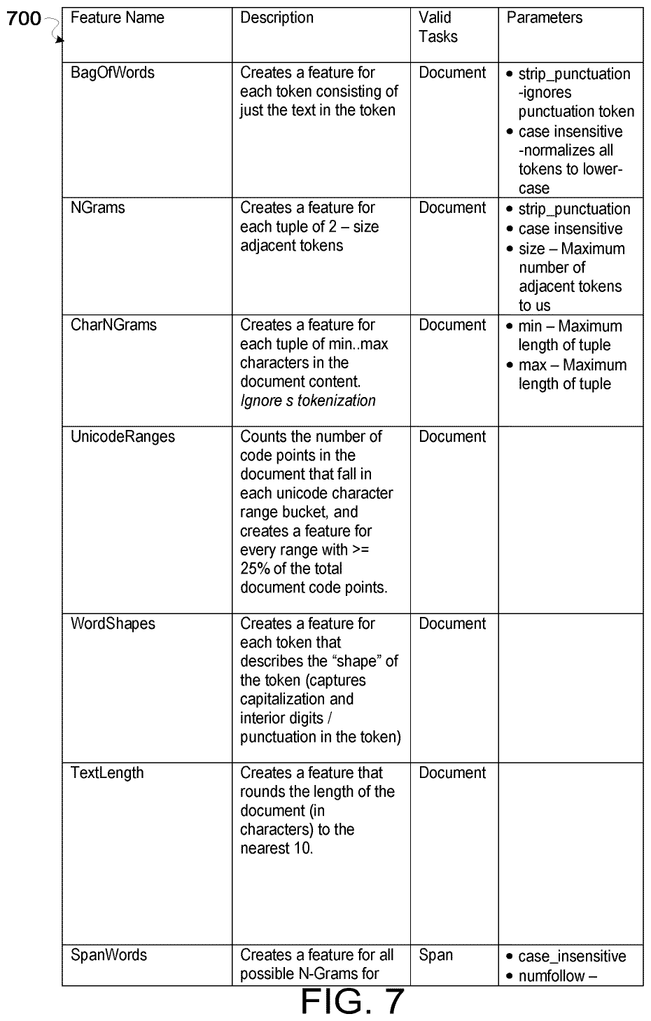

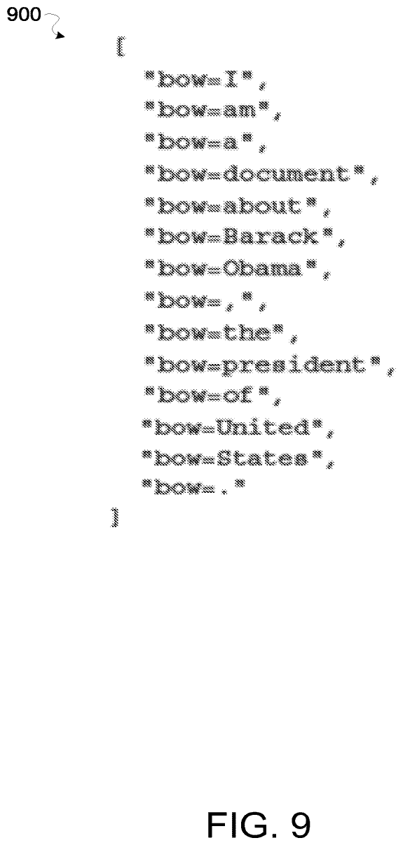

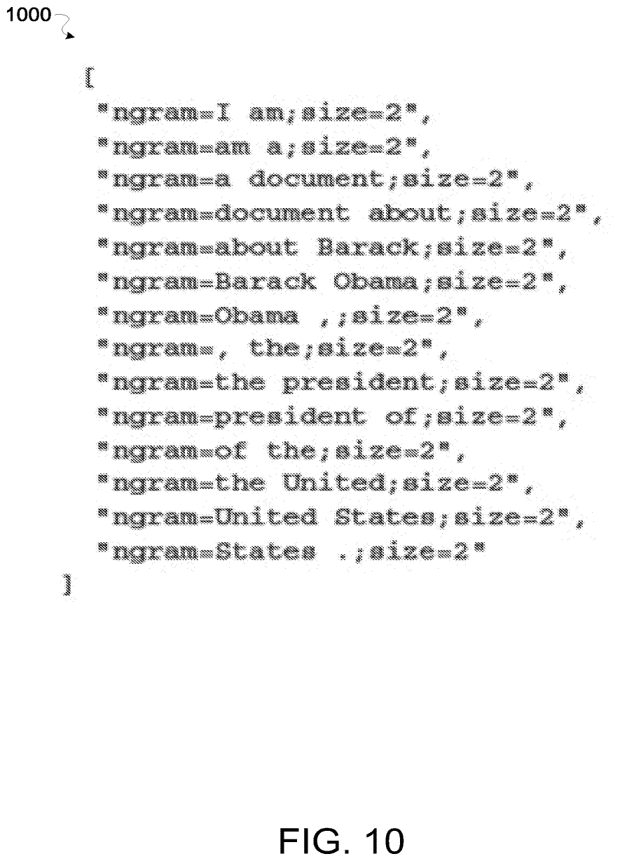

At step 640, the process continues by receiving one or more parameters for the selected feature types, wherein the one or more rules for generating features are defined at least in part by the parameters. More details about parameters will be described below with reference to FIGS. 7-10. At step 650, the process continues by generating features associated with the document to be processed based on the selected feature types and the received parameters. At step 660, the process concludes by outputting the generated features in a format common among all feature types. More details about the common format will be described below with reference to FIGS. 9 and 10.

In some embodiments, the plurality of feature types that the user can choose from comprises one or more feature types that generate features each comprising at least one combination of the accessed tokens, as in the examples in FIG. 9 and FIG. 10. A combination of tokens may consist of a single token.

Referring to FIG. 7, charts 700 shows an example set of feature types, whose names are listed in the first column under “Feature Name.” These feature types may be predefined by the system. As an example, the second listed feature type, “N Grams” is the feature type used in the example process in FIG. 5. The second column under “Description” represents a brief description of the functionality of the feature type named in the first column. For example, for the feature type N Grams, the description states, “Creates a feature for each tuple of 2—size adjacent tokens,” which is the output consistent with description at step 550, in FIG. 5.

In some embodiments, some feature types may be valid for document-scope tasks, while other feature types may be valid for span-scope tasks. In these cases, the third column in charts 700 provides an example of which feature types are valid for document-span tasks or span-scope tasks. In other cases, a feature type may be valid for both documents and spans.

In some embodiments, the feature types may allow for some variation of whether to include certain specific considerations, such as whether punctuation of the word matters (e.g., punctuation is ignored or taken into account when producing the output), or whether the processing should be case-sensitive (e.g. capitalization of a word is differentiated from said word with no capitalization). These example types of specific considerations and others may be listed in the fourth column of chart 700, under “Parameters.” Thus, when invoking a particular feature type, a user may specify whether to turn on or off these specific parameters (e.g., strip_punctuation=false or true).

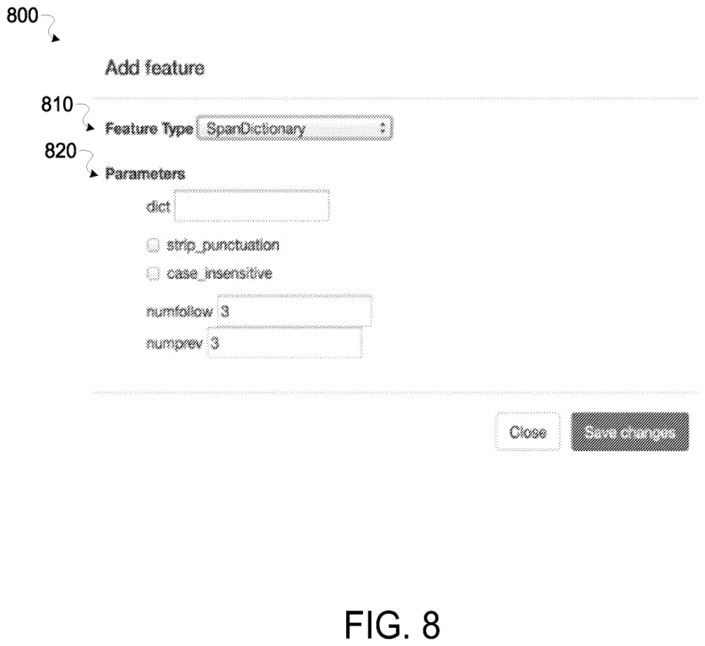

In some embodiments, names of the specific parameters supported by each feature type, and the range of values allowed for each parameter (e.g., strip_punctuation allows two values: false and true) may be stored in a machine-readable format. For example, the feature extracting algorithm may define a convention such that all feature types include metadata, such as Java class annotations, identifying each supported parameter and allowable value range. In some embodiments, the API module 205 in FIG. 2 may be configured to transmit all of the parameter information to user applications 225. In such embodiments, a user may select and configure feature types from a graphical user interface created from the transmitted parameters, such as the interface shown in FIG. 8.

The example feature types listed herein are merely a few of the many feature types that may be available or created. Due to the foundational architecture of the present disclosures, a client or customer, such as a user 132 or 152, may be able to develop or program their own feature types, while still utilizing commonly provided feature types originating from a host system, such as the network-based system 105.

Referring to FIG. 8, illustration 800 shows an example user interface for selection of feature types. In the example user interface, a user may select a feature type 810 and the parameters 820 associated with the feature types.

Referring to FIG. 9, illustration 900 shows an example output of an array of features based on the feature type, “Bag of Words,” as described in the chart in FIG. 7, according to some embodiments. In this case, the input to this feature type was the statement, “I am a document about Barack Obama, the president of the United States.” The Bag of Words feature type may be designed to generate an array of features having only the words in a span or document. In some cases, this feature type may record only the unique words in the span or document, such that in this case, the word “the” appears only once in the array of features in the example output of illustration 900. In some cases, this feature type may record each instance of a word. In some cases, a weighting will be applied to words, such that repeated words count more than lone words, but not necessarily at a weighting equivalent to the number of times a word is repeated. As shown, the array of features is provided in a common format that may be used for all feature types. That is, for example, the common generic output may include an array of features embedded in between two brackets, with each feature denoted after an “=”. The phrase “bow” denotes an abbreviation for the feature type “Bag of Words.”

Once the feature type has generated the array of features similar to the example shown in illustration 900, a natural language model may be trained on the array of features to learn about and confirm various characteristics about various words or phrases contained in the array of features.

Referring to FIG. 10, illustration 1000 shows another example output of features generated by a different feature type, according to some embodiments. In this case, the array of features in illustration 1000 was generated by the feature type “NGrams,” described in chart 700 and consistent with the description in FIG. 5. Again, the input text used to generate the array of features in illustration 1000 was the statement, “I am a document about Barack Obama, the president of the United States.” The feature type NGrams takes in as one parameter the number of tokens to make up each feature. In this case, that parameter was specified as 2 (i.e., size=2) (that is, the N in NGrams denotes generating features of size N tokens). As shown in FIG. 7, other parameters may be specified, such as whether to ignore punctuation. In this case, punctuation was not ignored, and as a result, some features include the punctuation, as shown.

Consistent with the format shown in FIG. 9, the format in illustration 1000 again includes an array of features in between two brackets, with each specific feature listed after the “=”. A semicolon separates the end of the feature with additional metadata, in this case a description of the size of each feature. Therefore the generated features are outputted in a common format, no matter what feature type or feature types are selected.

Once this feature type has generated the array of features similar to the example shown in illustration 1000, the natural language model may be trained on the array of features to learn about and confirm various characteristics about the input statement. For example, the two tokens put together forming the phrase “United States” is now listed as a single feature in the array of features of illustration 1000. The natural language model may be trained to recognize the two word phrase “United States,” using this specific feature. In contrast, the natural language model may have been unable to learn to recognize the phrase “United States” if just trained on the array of tokens, since no single token was generated to include the entire two word phrase of “United States.” Similarly, the natural language model may now be able to learn the whole name of “Barack Obama” using the array of features generated by the NGrams feature type with parameter “size”=2.

In a similar vein, many other feature types may be utilized to create different permutations of features out of a span or a document, in order to generate specific combinations of tokens that may be used to successfully train a natural language model. That is, one or more feature types may be used to “extract” desired features out of a span or a document in order to successfully train natural language model.

In addition to the feature types described with reference to FIGS. 7, 9 and 10, in some embodiments, based on the system architecture described herein, clients or customers may be capable of designing their own feature types, due to the common input format and common output format as described herein. The various feature types described herein are merely some examples, while an essentially unlimited number of feature types may actually be designed and programmed, and embodiments are not so limited.

In some embodiments, features associated with a document may not contain only a combination of tokens, but may be based on other characteristics of the document.

In some embodiments, the feature extraction process may further comprise accessing one or more tags attached to the one or more tokens, and the plurality of feature types that the user can choose from may comprise one or more feature types that generate features containing information in the tags. As part of the process which partitions a document into tokens, a plurality of tags may be attached to each token. For example, a token “9:00 AM” may be associated with a tag for “time.” As another example, a token “$1,000USD” may be associated with tags for “quantity” and “currency.” A more detailed description of tagging is described in provisional application U.S. Application 62/254,090, filed Nov. 11, 2015, titled “TOKENIZER AND TAGGER FOR LANGUAGE AGNOSTIC METHODS FOR NATURAL LANGUAGE PROCESSING,” U.S. patent application Ser. No. 14/964,512, filed Dec. 9, 2015, titled “INTELLIGENT SYSTEM THAT DYNAMICALLY IMPROVES ITS KNOWLEDGE AND CODE-BASE FOR NATURAL LANGUAGE UNDERSTANDING,” which is again incorporated by reference in its entirety. In such embodiments, the feature extracting algorithm may be performed on one or more tags in addition to the tokens. For example, a feature type may designate each of the tokens and each of the tags as a feature. Therefore, “$1,000USD” may have two additional features “tag=currency” and “tag=quantity.” As another example, a feature type may designate each of the tokens associated with a specific tag as a feature, ignoring other tokens.

In some embodiments, the feature extraction process may further comprise accessing metadata associated with the document to be processed, and the plurality of feature types that the user can choose from may comprise one or more feature types that generate features containing information in the metadata. For example, some document may contain within its metadata an existing crude classification. As another example, some document may contain within its metadata biographical information about the document author, such as the author's hometown or gender. The feature extracting algorithm may be performed on the metadata available with each document. For example, a feature type may designate the author's hometown as a feature (e.g., “hometown=San Francisco, CA”) when the document contains the author's hometown within its metadata, or to use a default “UNKNOWN” value if the document metadata does not contain author's hometown.

In some embodiments, a feature may comprise information in the metadata and a combination of tokens. For example, there may be a data set consisting of two sets of documents: one about the health-care industry, and one about the finance industry. Furthermore, assume that each document has some metadata identifying which industry it discusses. Given this information, some terms will be known to have dramatically different meanings depending on which industry is discussed (e.g., overweight, underweight). In such a case, it may be beneficial to create a feature type that designates each pair [industry, token] as a feature, rather than designating “industry” and “token” as features independently.

In some embodiments, the feature extraction process may further comprise generating statistics across a pool of documents, and the plurality of feature types that the user can choose from may comprise one or more feature types that generate features based on the statistics. For example, before the performance of feature extraction, aggregate statistics may be generated across the entire document set, including the distribution of document and word lengths. In such embodiments, the feature extracting algorithm may refer to the generated statistics when designating features. For example, a feature type may designate a feature indicating that a document is longer than, is shorter than or equals to the median or average length of the document set.

In some embodiments, the feature extraction process may further comprise accessing a list of entries, and the plurality of feature types that the user can choose from may comprise a feature type that generates a feature indicating whether the document to be processed contains tokens that match one or more of the list of entries. The feature extracting algorithm may refer to one or more pre-developed knowledge bases while designating features. For example, a feature type configured with a list of proper names (commonly referred to as a dictionary or a gazetteer) may be used to designate each token that matches an entry in the list as a feature. The proper names could be company names, city/state/country names, chemical compound names, names of infectious diseases, etc.

In some embodiments, the feature extraction process may further comprise accessing a list of word vectors, and the plurality of feature types that the user can choose from may comprise a feature type that generates features containing one or more word vectors each corresponding to a combination of the accessed tokens. For example, a feature type configured with a model of distributional word embeddings (such as those generated by Word2Vec) may be used to designate a vector representation of each sequence of tokens as a feature. Examples of word vectors are “acknowledges”=>[−0.168159 −0.245182 −0.278258 −0.149784 . . . −0.297952 −0.063482 0.001954 0.028807], and “dusty”=>[0.154446 0.406346 0.206915 0.301534 . . . 0.004753 −0.217322 0.051078−0.094273].

In some embodiments, the feature extraction feature may comprise calculating frequencies of occurrence of one or more generated features within a pool of documents; and storing the frequencies of occurrence in a format accessible by a module for submitting documents for human annotation. For example, after the performance of feature extraction, statistics are generated across the entire document set, including the frequencies of occurrence of each feature within the document set. Such statistics may be stored in a table associating each feature with the calculated statistic. In some embodiments, these statistics may be used by an intelligent queuing module to select one or more documents from the document set for human annotation. For example, the intelligent queuing module may select documents containing rare features, to improve the natural language model's understanding of such features. Intelligent queuing is described in more detail in U.S. patent application Ser. No. 14/964,520, filed Dec. 9, 2015, titled “OPTIMIZATION TECHNIQUES FOR ARTIFICIAL INTELLIGENCE,” which is again incorporated by reference in its entirety.

In some embodiments, the feature extraction process may further comprise presenting, in a user interface, one or more features associated with a document. The presentation may occur, for example, after a document has been classified by the natural language model. Therefore, a user may gain insight into what feature(s) causes the document to be classified this way.

In some embodiments, the document to be processed is in one or more languages; the one or more tokens are accessed in a language agnostic format; and the generated features are outputted in a language agnostic format. In this way, the feature extraction of the present disclosure enables the feature extraction programs and all later programs utilizing the features to be “language agnostic,” meaning the programs need not concern themselves with what language or languages the documents are written in.

An apparatus for tokenizing text for natural language processing may comprise one or more processors configured to perform the process described above.

A non-transitory computer readable medium may comprise instructions that, when executed by a processor, cause the processor to perform the process described above.

Referring to FIG. 11, the block diagram illustrates components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be connected (e.g., networked) to other machines. In a networked deployment, the machine 1100 may operate in the capacity of a server machine 110 or a client machine in a server-client network environment, or as a peer machine in a distributed (e.g., peer-to-peer) network environment. The machine 1100 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine 1100 is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a video display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or other pointing instrument), a storage unit 1116, a signal generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein, including, for example, any of the descriptions of FIGS. 1-10. The instructions 1124 may also reside, completely or at least partially, within the main memory 1104, within the processor 1102 (e.g., within the processor's cache memory), or both, before or during execution thereof by the machine 1100. The instructions 1124 may also reside in the static memory 1106.

Accordingly, the main memory 1104 and the processor 1102 may be considered machine-readable media 1122 (e.g., tangible and non-transitory machine-readable media). The instructions 1124 may be transmitted or received over a network 1126 via the network interface device 1120. For example, the network interface device 1120 may communicate the instructions 1124 using any one or more transfer protocols (e.g., HTTP). The machine 1100 may also represent example means for performing any of the functions described herein, including the processes described in FIGS. 1-10.

In some example embodiments, the machine 1100 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1122 able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database 115, or associated caches and servers) able to store instructions 1124. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device 120 or 130, as well as cloud-based storage systems or storage networks that include multiple storage apparatus or devices 120 or 130. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 1122 is non-transitory in that it does not embody a propagating signal. However, labeling the tangible machine-readable medium 1122 as “non-transitory” should not be construed to mean that the medium is incapable of movement; the medium should be considered as being transportable from one physical location to another. Additionally, since the machine-readable medium 1122 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1122 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1102 or a group of processors 1102) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1102 or other programmable processor 1102. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1108) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1102 that are temporarily configured (e.g., by software) or permanently configured to perform the relevant operations. Whether temporarily or permanently configured, such processors 1102 may constitute processor-implemented modules that operate to perform one or more operations or functions described herein. As used herein, “processor-implemented module” refers to a hardware module implemented using one or more processors 1102.

Similarly, the methods described herein may be at least partially processor-implemented, a processor 1102 being an example of hardware. For example, at least some of the operations of a method may be performed by one or more processors 1102 or processor-implemented modules. As used herein, “processor-implemented module” refers to a hardware module in which the hardware includes one or more processors 1102. Moreover, the one or more processors 1102 may also operate to support performance of the relevant operations in a “cloud computing” environment or as a “software as a service” (SaaS). For example, at least some of the operations may be performed by a group of computers (as examples of machines 1100 including processors 1102), with these operations being accessible via a network 1126 (e.g., the Internet) and via one or more appropriate interfaces (e.g., an API).

The performance of certain operations may be distributed among the one or more processors 1102, not only residing within a single machine 1100, but deployed across a number of machines 1100. In some example embodiments, the one or more processors 1102 or processor-implemented modules may be located in a single geographic location (e.g., within a home environment, an office environment, or a server farm). In other example embodiments, the one or more processors 1102 or processor-implemented modules may be distributed across number of geographic locations.

Unless specifically stated otherwise, discussions herein using words such as “processing,” “computing,” “calculating,” “determining,” “presenting,” “displaying,” or the like may refer to actions or processes of a machine 1100 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method for extracting features for natural language processing, the method comprising:
accessing, by one or more processors in a natural language processing platform, one or more tokens generated from a document to be processed;
receiving, by the one or more processors, one or more feature types defined by a user;
receiving, by the one or more processors, a selection of one or more feature types from a plurality of system-defined and user-defined feature types, wherein each feature type comprises one or more rules for generating features;
receiving, by the one or more processors, one or more parameters of the selected feature types, wherein the one or more rules for generating features are defined at least in part by the parameters;
generating, by the one or more processors, features associated with the document to be processed based on the selected feature types and the received parameters; and
outputting, by the one or more processors, the generated features in a format common among all feature types.

2. The method of claim 1, wherein the plurality of feature types comprises one or more feature types that generate features each comprising at least one combination of the accessed tokens.

3. The method of claim 1, further comprising accessing one or more tags attached to the one or more tokens, wherein the plurality of feature types comprises one or more feature types that generate features containing information in the tags.

4. The method of claim 1, further comprising accessing metadata associated with the document to be processed, wherein the plurality of feature types comprises one or more feature types that generate features containing information in the metadata.

5. The method of claim 4, wherein the plurality of feature types comprises a feature type that generates features each comprising information in the metadata and a combination of tokens.

6. The method of claim 1, further comprising generating statistics across a pool of documents, wherein the plurality of feature types comprises one or more feature types that generate features based on the statistics.

7. The method of claim 6, wherein the statistics comprise an average or median document length in the pool, and the plurality of feature types comprises a feature type that generates a feature indicating whether the document to be processed is longer than, is shorter than, or equals to the average or median document length.

8. The method of claim 1, further comprising accessing a list of entries, wherein the plurality of feature types comprises a feature type that generates a feature indicating whether the document to be processed contains one or more tokens that match one or more of the list of entries.

9. The method of claim 1, further comprising accessing a list of word vectors, wherein the plurality of feature types comprises a feature type that generates features containing one or more word vectors each corresponding to a combination of the accessed tokens.

10. The method of claim 1, further comprising:
calculating frequencies of occurrence of one or more generated features within a pool of documents; and
storing the frequencies of occurrence in a format accessible by a module for submitting documents for human annotation.

11. The method of claim 1, further comprising presenting, in a user interface, one or more features associated with a document.

12. The method of claim 1, wherein:
the document to be processed is in one or more languages;
the one or more tokens are accessed in a language agnostic format; and
the generated features are outputted in a language agnostic format.

13. An apparatus for extracting features for natural language processing, the apparatus comprising one or more processors configured to:
access one or more tokens generated from a document to be processed;
receive one or more feature types defined by user;
receive selection of one or more feature types from a plurality of system-defined and user-defined feature types, wherein each feature type comprises one or more rules for generating features;
receive one or more parameters for the selected feature types, wherein the one or more rules for generating features are defined at least in part by the parameters;
generate features associated with the document to be processed based on the selected feature types and the received parameters; and
output the generated features in a format common among all feature types.

14. The apparatus of claim 13, wherein the plurality of feature types comprises one or more feature types that generate features each comprising at least one combination of the accessed tokens.

15. The apparatus of claim 13, wherein the one or more processors are further configured to access one or more tags attached to the one or more tokens, and the plurality of feature types comprises one or more feature types that generate features containing information in the tags.

16. The apparatus of claim 13, wherein the one or more processors are further configured to access metadata associated with the document to be processed, and the plurality of feature types comprises one or more feature types that generate features containing information in the metadata.

17. The apparatus of claim 13, wherein the one or more processors are further configured to generate statistics across a pool of documents, and the plurality of feature types comprises one or more feature types that generate features based on the statistics.

18. The apparatus of claim 13, wherein
the document to be processed is in one or more languages;
the one or more tokens are accessed in a language agnostic format; and
the generated features are outputted in a language agnostic format.

19. A non-transitory computer readable medium comprising instructions that, when executed by a processor, cause the processor to:
access one or more tokens generated from a document to be processed;
receive one or more feature types defined by user;
receive selection of one or more feature types from a plurality of system-defined and user-defined feature types, wherein each feature type comprises one or more rules for generating features;
receive one or more parameters for the selected feature types, wherein the one or more rules for generating features are defined at least in part by the parameters;
generate features associated with the document to be processed based on the selected feature types and the received parameters; and
output the generated features in a format common among all feature types.

20. The non-transitory computer readable medium of claim 19, wherein the plurality of feature types comprises one or more feature types that generate features each comprising at least one combination of the accessed tokens.
